(19) United States
(12) Patent Application Publication
(10) Pub. No.: US 2026/0329545 A1
(43) Pub. Date: Oct. 22, 2026

(54) System and Methods for Generating Complex Infrastructure Designs Using Sequence Processing Models

(71) Applicant: Google LLC, Mountain View, CA (US)

(72) Inventors: Praveen Killamsetti, Milpitas, CA (US); Haein Moon, Seattle, WA (US); Thirumalesh V. Reddy, San Jose, CA (US)

(21) Appl. No.: 19/636,448

(22) Filed: Apr. 1, 2026

Related U.S. Application Data
(60) Provisional application No. 63/781,891, filed on Apr. 1, 2025.

(51) Int. Cl. G06F 8/10

(52) U.S. Cl. CPC G06F 8/10

(57) ABSTRACT

The present disclosure provides computer-implemented methods, systems, and devices for generating application design specifications. A computing system receives an application request from a user. The computing system generates, via a machine-learned model, an initial design specification with a plurality of components for a structure of an application based on the application request, wherein the initial design specification comprises an intermediate representation of a design graph. The computing system accesses a list of services available to the user and determines, for a respective component, a first service from the list to perform an associated task. The computing system configures one or more parameters of the first service based on the application request to produce a final design specification in which specific services are selected and configured for each component. The computing system converts the final design specification to a destination format.

### PRIORITY CLAIM

The present application claims priority to U.S. Provisional Application No. 63/781,891 filed Apr. 1, 2025, which is hereby incorporated by reference in its entirety.

### FIELD

The present disclosure relates generally to sequence processing models. More particularly, the present disclosure relates to a system that generates complex infrastructure design using sequence processing models.

### BACKGROUND

As the capability of large sequence processing models such as large language machine-learned models increases, the services that those models can provide continue to expand. One potential application for large language machine-learned models (LLMs) is generating applications. Unfortunately, large, complex applications that require complicated infrastructure make it difficult for LLMs to design effectively. The process includes multiple steps and significant internal connections between services. Without a specialized system, it may be difficult for LLMs to produce a satisfactory application design.

### SUMMARY

Aspects and advantages of embodiments of the present disclosure will be set forth in part in the following description, or can be learned from the description, or can be learned through practice of the embodiments.

An example aspect of the present disclosure is directed to a computing system. The system can include one or more processors and one or more non-transitory computer-readable media that collectively store instructions that, when executed by the one or more processors, cause the computing system to perform operations. The operations can include receiving an application request from a user. The operations can further include generating, by a machine-learned model, an initial design specification with a plurality of components for an initial structure of an application based on the application request, wherein the initial design specification comprises an intermediate representation of a design graph. The operations can further include accessing a list of services available to the user. The operations can further include determining, for a respective component in the plurality of components, a first service from the list of services available to the user to perform a task associated with the respective component. The operations can further include configuring one or more parameters of the first service based on the application request. The operations can further include producing a final design specification in which specific services have been selected and configured for each component in the initial design specification. The operations can further include converting the final design specification to a destination format.

Another example aspect of the present disclosure is directed to a computer-implemented method. The method comprises receiving, by a computing system with one or more processors, an application request from a user. The method further comprises generating, by a machine-learned model implemented by the computing system, an initial design specification with a plurality of components for a structure of an application based on the application request, wherein the initial design specification comprises an intermediate representation of a design graph. The method further comprises accessing, by the computing system, a list of services available to the user. The method further comprises determining, by the computing system, for a respective component in the plurality of components, a first service from the list of services available to the user to perform a task associated with the respective component. The method further comprises configuring, by the computing system, one or more parameters of the first service based on the application request. The method further comprises producing, by the computing system, a final design specification in which specific services have been selected and configured for each component in the initial design specification. The method further comprises converting, by the computing system, the final design specification to a destination format.

Another example aspect of the present disclosure is directed to one or more non-transitory computer-readable media that collectively store instructions that, when executed by one or more computing devices, cause the one or more computing devices to perform operations. The operations can include receiving an application request from a user. The operations can further include generating, by a machine-learned model, an initial design specification with a plurality of components for an initial structure of an application based on the application request, wherein the initial design specification comprises an intermediate representation of a design graph. The operations can further include accessing a list of services available to the user. The operations can further include determining, for a respective component in the plurality of components, a first service from the list of services available to the user to perform a task associated with the respective component. The operations can further include configuring one or more parameters of the first service based on the application request. The operations can further include producing a final design specification in which specific services have been selected and configured for each component in the initial design specification. The operations can further include converting the final design specification to a destination format.

### BRIEF DESCRIPTION OF THE DRAWINGS

Detailed discussion of embodiments directed to one of ordinary skill in the art is set forth in the specification, which makes reference to the appended figures, in which:

FIG. 1A represents an example of an application design system for automatically generating the structure for an application in accordance with example embodiments of the present disclosure;

FIG. 1B illustrates an application design system similar to the system depicted in FIG. 1A, with the primary difference being the source of the input requirements in accordance with example embodiments;

FIG. 2 represents an example application design system in accordance with example embodiments of the present disclosure;

FIG. 3 represents an example design agent in accordance with example embodiments of the present disclosure;

FIG. 4 represents an example application design system in accordance with example embodiments of the present disclosure;

FIG. 5 represents an example application design system in accordance with example embodiments of the present disclosure;

FIG. 6 represents an example architecture for a design agent in accordance with example embodiments of the present disclosure;

FIG. 7 represents a process for inputting user requirements into the application design system in accordance with example embodiments of the present disclosure;

FIG. 8 represents a process for generating an application in accordance with example embodiments of the present disclosure;

FIG. 9 depicts a block diagram of an architectural graph in accordance with example embodiments of the present disclosure;

FIG. 10 is a block diagram of an example processing flow for transforming an input image into a formatted design specification in accordance with example embodiments of the present disclosure;

FIG. 11 is a block diagram illustrating the logic for a recursive component customization process in accordance with example embodiments of the present disclosure;

FIG. 12 is a block diagram illustrating a process for improving an application design across various dimensions in accordance with example embodiments of the present disclosure;

FIG. 13 is a flow diagram illustrating an example method for application design in accordance with example embodiments of the present disclosure;

FIG. 14 depicts a block diagram of an example user computing system for generating application structures according to example embodiments of the present disclosure;

FIG. 15 is a block diagram of an example processing flow for using machine-learned model(s) to process input(s) to generate output(s);

FIG. 16 is a block diagram of an example implementation of an example machine-learned model configured to process sequences of information;

FIG. 17 is a block diagram of an example technique for populating an example input sequence;

FIG. 18 is a block diagram of an example computing device that performs according to example embodiments of the present disclosure; and

FIG. 19 is a block diagram of an example computing device that performs according to example embodiments of the present disclosure.

Reference numerals that are repeated across plural figures are intended to identify the same features in various implementations.

### DETAILED DESCRIPTION

Generally, the present disclosure is directed toward a system for generating complex applications using infrastructure design. To do so, an application design system can receive a request from a user. The request can describe the purpose or function of the application and at least some details about how it should be designed or structured, for example, by providing a natural language prompt, a design document, or a multi-modal input such as an architecture diagram image. In some examples, the initial request can be analyzed to generate an initial design specification for the application. The initial design specification can be structured as a graph with a plurality of nodes and edges, where the graph can serve as an intermediate representation that is agnostic to any specific Infrastructure-as-Code (IaC) format. Each node can represent a service component in the system, and each edge can represent connections between service components. In this stage, the service components are described based on the task they are to perform and have not yet been specifically associated with particular services. Rather than generating each node from scratch, the application design system can use existing services to construct the application. In this way, the application design system is not responsible for generating entirely new services. Instead, to help the user customize existing services, the application design system can identify a list of services to which the user has access. For example, the system can access the user profile to determine which services the user can access and generate a list based on that profile. Once the system has determined the list of permitted services, it can analyze each node in the graph to associate a particular service from the list of services with that node. Once all the nodes have been selected, the system can determine whether all of the edges between the components will function appropriately. For example, it can determine whether each service can connect as described in the initial design specification.

Each service can have one or more parameters that are to be specified before use. The application design system can identify one or more user intents from the application request. Once the user intents have been determined, the application design system can use those intents to customize the specific parameters of each service, for instance, by determining regions, machine types, or scaling policies. Once all nodes have been assigned to specific services and all of the services have been customized based on these returns, the application design system can generate the final design document. The final design document can be provided to a system that converts the design document into its desired format (e.g., Terraform, gcloud, Kubernetes YAML, or an Application Design Center API specification). The converted document can then be transmitted to the user for use.

More specifically, the application design system can be a service provided at a service system. In some implementations, the system can include a hierarchical task decomposition framework that classifies user intent at a root resolver level. The application design system can enable users to request specific complicated applications, and those applications can be designed, at least in part, by the application design system. For example, a user can request an e-commerce application with specific microservices, and the system can decompose this into application-level, component-level, and resource-level tasks.

The application design system can generate a structured infrastructure intent based on that request. The structured infrastructure intent can include information extracted from the natural language description provided by the user. For example, the application design system can extract the specific workload type, the performance needed, the location, and other information about the application, for instance, by creating a table of requirements for real-time data processing and geographical location.

In some examples, the application design system can assign a design agent to manage the process of generating the application. The design agent can be an artificial intelligence (AI) agent that can provide instructions to different components of the application design system, receive the output of those components, and, based on previously determined user intent, provide feedback to the components. In some implementations, the design agent can utilize multi-step reasoning to align solutions with user intent. In this way, an iterative process can improve the design over time.

The design agent can request a design output model to generate an initial design for the application. In some examples, the design output model can generate an initial design that describes the application as a set of components and connections between those components. In some examples, this can be represented as a graph with nodes and edges. Each node can represent a particular component that provides a particular task and each edge is the connection between the components. In the initial design, the components are designated generally by the tasks they perform and have not been associated with particular services or code yet. For example, a skeleton design can identify a load balancer node connected to a frontend service node without specifying a particular cloud product.

The design agent can then improve the initial design specification. The design can be improved in various dimensions like security, availability and other dimensions. For example, if the intent description says avoid distributed denial of service (DDoS) attacks, the design agent can add a new node to the design that can provide a firewall policy, for instance, by attaching a Cloud Armor policy to a load balancer node. These improvements can be rules-based additions to design for each dimension. In some implementations, the system can also improve the design by applying multi-region deployment patterns or adding transport layer security (TLS) policies.

The design agent can, using a configuration system, configure each component in the design. For example, once the system has assigned specific services to each node in the initial design, a task planner moves to configuration recommendations for each component. Each component is a separate service that requires a different set of configurations. This step will create a set of child abstract tasks and execute them in parallel. Component configuration generation is a multi-step process. The configuration for each component is determined based on various dimensions specified in the user intent. For example, a database component can be configured for high availability by setting regional availability types and SSD disk types based on user performance requirements.

In some implementations, the system can perform cross-cloud infrastructure translation. For example, the system can ingest architecture patterns from other cloud providers, such as AWS or Azure, and translate them into a design specification using validated building blocks. This can include mapping vendor-specific triggers to corresponding service components in a different cloud environment.

In some implementations, the system can utilize multi-modal intent support to process visual inputs. For example, a user can provide an image of a handwritten architecture sketch, and the system can convert this image into a natural language summary before building the Design Spec. This can include identifying spatial relationships in a diagram and translating them into logical edges in a design graph.

In some implementations, the design process can be restricted to using a library of validated building blocks. For example, the system can select from pre-approved service, workload, or asset templates that are governed by enterprise constraints. This can help improve the likelihood that the generated infrastructure follows security best practices and organizational policies.

Once the design has been configured, the design agent can request that the design specification be converted into its desired format. For example, if the application is designed for a specific platform, the final specification can be converted into a format for that platform. In some implementations, the system can export the design as Terraform code that includes automatic registration of resources with a management hub.

The systems and methods of the present disclosure provide a number of technical effects and benefits. One example of technical effects and benefits can include enhancing the ability of the machine-learned model to accurately generate an application that matches a description provided by the user. Doing so accurately can reduce the latency, and the number of computational resources needed to provide an application structure. Specifically, using an initial design process can enable the system to quickly and accurately determine a structure of an application and identify useful services. Doing so can significantly reduce the time and cost needed to produce useful application designs using a machine-learned model.

Another example of technical effects and benefits can include improved security and predictability in infrastructure generation. By utilizing validated building block templates rather than generating raw code from scratch, the system can improve the likelihood that the resulting design adheres to secure-by-design principles. For instance, restricting the model to pre-configured modules can reduce the occurrence of hallucinations or non-existent parameters, thereby improving the reliability of the deployment configuration.

A further example of technical effects and benefits can include increased architectural flexibility through an intermediate representation. Using a design specification that is agnostic to the final output format can enable the system to translate a single design into multiple different IaC languages without requiring the model to be retrained for each specific syntax. For example, a single graph-based blueprint can be converted into both gcloud commands and Terraform scripts, which can improve the efficiency of managing cross-functional infrastructure requirements.

With reference now to the Figures, example embodiments of the present disclosure will be discussed in further detail.

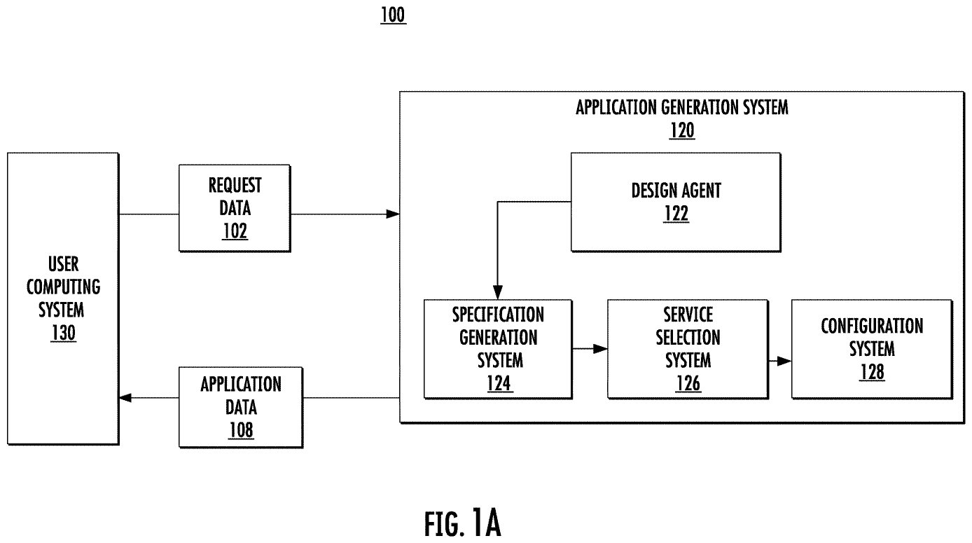

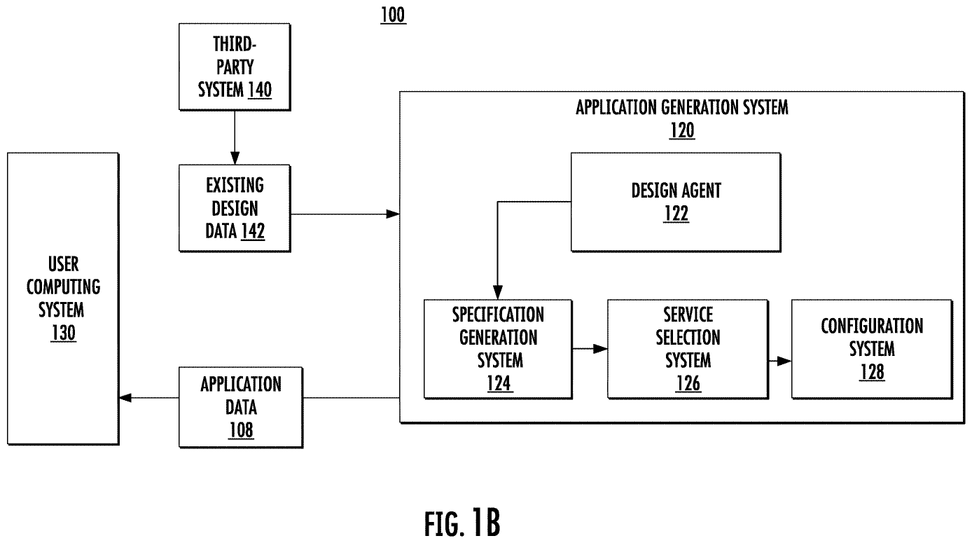

FIG. 1A represents an example of an application design system 100 for automatically generating the structure for an application in accordance with example embodiments of the present disclosure. In this example, a user computing system 130 can transmit request data 102 to an application generation system 120. Request data 102 can include a description of the specific application the user would like to generate, which can be provided as a multi-modal intent such as a natural language prompt or an architecture diagram image. Application generation system 120 includes a design agent 122.

The design agent 122 is an AI-controlled agent that can interact with other systems of the application generation system 120 to help ensure that the user's intended requested application is generated. In some implementations, the design agent 122 can utilize hierarchical task decomposition to break down complex design problems into manageable sub-tasks. The design agent 122 can provide the request data 102 (or a modified version of the data to identify the user's intents) to the specification generation system 124. The specification generation system 124 can generate an initial specification based on the request data, including the modules and connections between the modules. In some examples, this can be represented as a graph with nodes and edges, for instance, by identifying a load balancer node that connects to a frontend service node. That initial specification can then be provided to the service selection system 126.

The service selection system 126 can determine a specific service for each component or module in the initial specification. In some examples, the service selection system 126 can access user profile information indicating what services the user has permission to access. Each of these services can then be analyzed to determine whether it can provide the service for a specific module. For example, if a particular module is tasked with implementing a search system, the service selection system 126 can determine whether any available services, such as a distributed search and analytics backend, can provide search services. If so, at least one of them is selected, and the design specification is updated to include the selected search service.

Each service can have a variety of parameters that define how the service operates. In some examples, this can be determined based on information describing the service and its parameters in a documentation store, such as a catalog of building block templates. The configuration system 128 can configure each service once it has been included in the specification. In some implementations, the configuration system 128 can select parameters based on a structured input requirement spec that extracts performance and location requirements from the user intent. For example, the system can configure a database node with a specific disk type and regional availability based on a user's performance and scalability needs.

In some examples, the user may have explicitly indicated a particular configuration that they would like. In other examples, the configuration system 128 working with the design agent 122 can determine, based on context data, which parameters should be set to which values. In some examples, the design agent 122 can review all the selected service configurations to help improve the likelihood that they match the user's intent extracted from the request data 102. Once the initial specification has been updated to include specific services and the parameters for those services, the design agent 122 can receive the finalized specification. In some examples, the finalized specification can be converted from the graph storage format of the application generation system 120 into the format in which the application will be running, such as Terraform or Kubernetes YAML. The application data 108 can then be provided to the user computing system 130.

In some implementations, the design agent 122 can utilize a plan classifier task to route the design intent to an appropriate abstract task. The system can classify the intent into application-level, component-level, or resource-level categories to determine the appropriate planning model. For example, a request to design an entire e-commerce suite can trigger an application design abstract task, whereas a request for a single storage bucket can trigger a resource design task.

In some implementations, the specification generation system 124 can generate a design specification that serves as a platform-independent intermediate representation. This design specification can represent the infrastructure as a graph where each node is backed by a validated building block template. For example, the design specification can identify a storefront gateway node that is connected to a catalog service node using a YAML or JSON format.

In some implementations, the application generation system 120 can include an iterative refinement loop to improve the design specification across multiple dimensions. The design agent 122 can add or modify nodes based on non-functional requirements such as security, reliability, and cost. For example, if the user intent indicates a need for DDoS protection, the design agent 122 can automatically attach a Cloud Armor firewall policy node to the load balancer in the design graph.

In some implementations, the service selection system 126 can be restricted to using a library of validated building block templates. These building blocks can be pre-configured to follow organizational security policies and best practices. For example, the system can require that all database components be selected from a set of templates that have encryption and regional replication enabled by default.

In some implementations, the application generation system 120 can perform cross-cloud translation to migrate architectures from other environments. The system can ingest design data 142 from a third-party system 140 and map foreign infrastructure patterns to corresponding predetermined building blocks associated with the application generation system 120. For example, an template associated with a third-party system can be translated into the intermediate design specification format before being exported as a configuration associated with the application generation system.

FIG. 1B illustrates an application design system 100 similar to the system depicted in FIG. 1A, with the primary difference being the source of the input requirements in accordance with example embodiments. In some implementations, the application generation system 120 can receive existing design data 142 from a third-party system 140 instead of, or in addition to, direct user request data. This existing design data 142 can represent an infrastructure configuration from another environment, such as a different cloud provider or an on-premises data center, which can then be processed to generate a new application design. For example, the third-party system 140 can provide a template that represents a legacy architecture in an IaC manner, which the application generation system 120 can ingest to facilitate a cloud migration process.

The third-party system 140 can, based on a user request, provide various types of structured or unstructured data as the existing design data 142. In some implementations, the system can receive vendor-specific templates (e.g., Amazon web services (AWS) CloudFormation or Azure Resource Manager templates), and translate them into a vendor-neutral intermediate representation. The design agent 122 can coordinate this translation by identifying corresponding service components within a validated building block library. For example, the system can ingest a template defining a Lambda function and a DynamoDB table and map these entities to a Cloud Run service and a Cloud SQL database within the internal design specification.

The specification generation system 124 can process the existing design data 142 to construct a design specification that maintains the architectural intent of the original system. In some implementations, this process can involve generating a graph-based representation where nodes and edges reflect the topology of the imported infrastructure. The specification generation system 124 can analyze the connections defined in the existing design data 142 to ensure that the new design preserves traffic flows. For instance, if the imported data describes a three-tier web application, the generated design specification can include nodes for a load balancer, a web server layer, and a database layer with edges representing their mutual dependencies.

The service selection system 126 can then associate each node in the imported design specification with specific services available in the target environment. In some implementations, the system can utilize a mapping logic to find the nearest equivalent product for each imported resource. This selection can be governed by validated building blocks to ensure that the newly assigned services meet security and compliance standards. For example, a virtual machine defined in the existing design data 142 can be associated with a specific Compute Engine machine type that matches the original resource's CPU and memory specifications.

Following service selection, the configuration system 128 can refine the parameters of each service to align with the target environment's requirements. In some implementations, the configuration system 128 can extract configuration metadata from the existing design data 142 and apply it to the new service components. This can include setting network configurations, storage limits, or identity and access management policies. For example, the system can extract firewall rules from a third-party configuration and translate them into corresponding virtual private cloud firewall rules or cloud armor policies within the final design. The resulting application data 108 is then provided to the user computing system 130 in a format suitable for deployment.

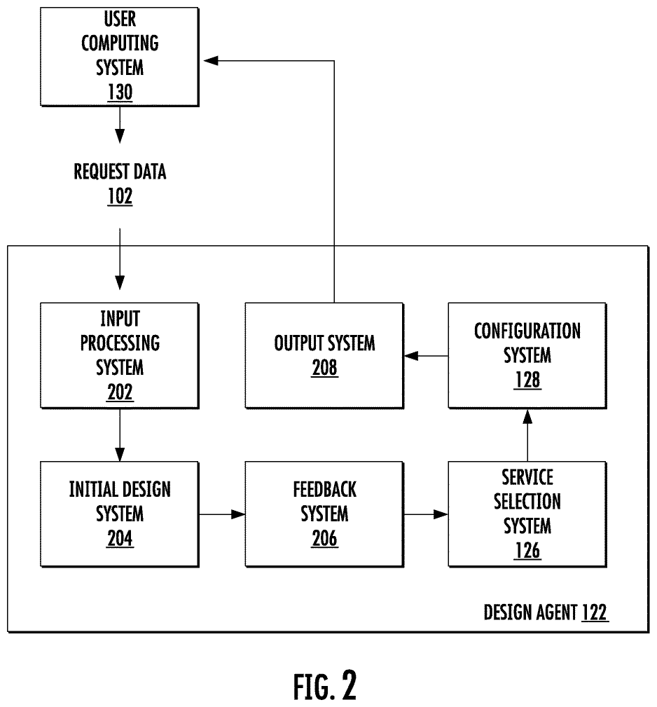

FIG. 2 represents an example application design system in accordance with example embodiments. In some implementations, the user computing system 130 can transmit request data 102 to the design agent 122. In this example, the design agent 122 can include an input processing system 202, an initial design system 204, a feedback system 206, a service selection system 126, a configuration system 128, and an output system 208. Each component can work in a sequence to translate a multi-modal design intent into a deployable configuration.

In some implementations, the input processing system 202 can receive the request data 102. The input processing system 202 can convert a multi-modal input, such as an architecture diagram image, into a natural language description. In other examples, the textual description in the request data 102 can be analyzed to determine one or more user intents and extract a structured input requirement spec. For instance, the system can extract specific performance requirements like 10,000 queries per second (QPS) from a natural language prompt.

Once the input processing system 202 has finished processing the request data 102, the system can pass the information to the initial design system 204. In some implementations, the initial design system 204 can use the analyzed request data 102 to generate an initial design specification for the application. The initial design specification can include modules and connections and can be described as a graph with nodes and edges. For example, an initial skeleton design can identify a load balancer node that connects to a frontend service node before any specific cloud services are assigned.

In some implementations, the initial design can be passed from the initial design system 204 to the feedback system 206. Based on the initial design, the feedback system 206 can determine whether any additional nodes need to be added or whether the described connections need to be changed to improve dimensions like security or reliability. For example, if the user intent indicates a need to avoid denial-of-service attacks, the feedback system 206 can attach a firewall policy node to the load balancer in the design graph.

The updated design is passed by the feedback system 206 to the service selection system 126. In some implementations, the service selection system 126 can determine the appropriate service to fulfill that role for each module. This selection can be based on the user's profile, which describes the services to which they have access. For example, the system can select a specific Cloud SQL building block template to fulfill a generic database node requirement in the architecture graph.

Once the design has been updated to include specific services, it can be passed by the service selection system 126 to the configuration system 128. In some implementations, the configuration system 128 can aid in determining, for each service, one or more parameters that need to be configured or customized based on a predefined schema. These parameters can be customized based on the request data 102 or any determined user intent. For example, the configuration system 128 can set the machine type for a compute node to a high-performance family if the intent specifies real-time data processing.

In some implementations, the configuration system 128 can utilize rule-based recommendations to suggest parameter values. For example, the system can automatically enable multi-zone availability for a database if the user prompt specifies high reliability. The fully updated design specification can be passed to the output system 208.

In some implementations, the output system 208 can convert the final specification into a target format based on the user's request. This format can be based on the platform the user has access to or on which they wish to deploy the application. For example, the output system 208 can translate the intermediate design specification into a set of Terraform configurations or Kubernetes YAML files.

In some implementations, the system can support cross-cloud translation for infrastructure migration. For example, the input processing system 202 can ingest design data from a third-party system, such as an web services template, and map those resources to corresponding building blocks associated with the system. The output system 208 can then transmit the converted specification back to the user computing system 130.

In some implementations, the design agent 122 can implement hierarchical task decomposition to manage the design process. The system can break down a high-level application design task into multiple component-level and resource-level sub-tasks. For example, the system can trigger a separate task network to handle the specific security posture configuration for a network gateway component.

In some implementations, the output system 208 can convert the design specification to a specific target API format. This allows the user to continue the design process in a full-screen canvas view with human-in-the-loop review capabilities. For example, a user can review a code diff in an interface before accepting a suggested modification to a database tier.

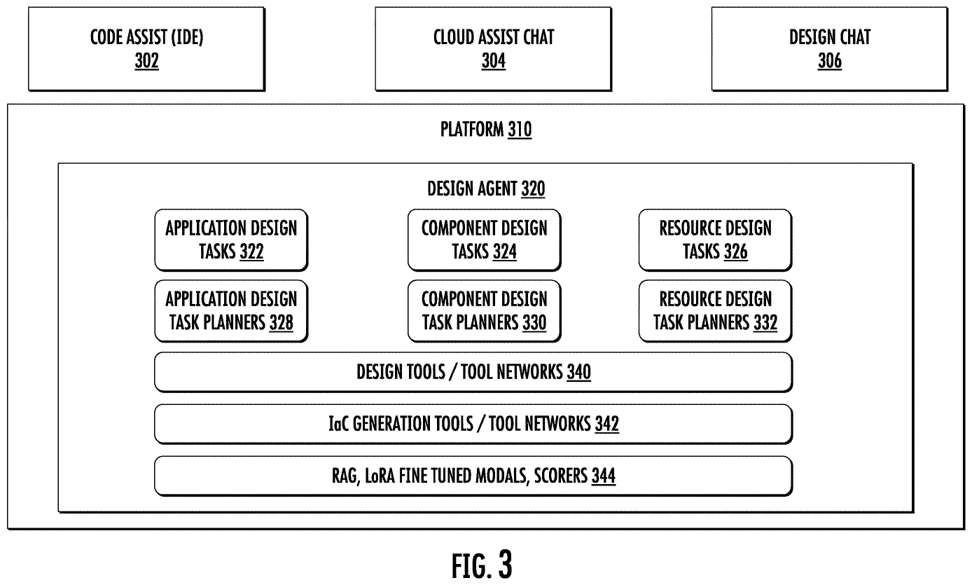

FIG. 3 represents an example design agent 320 in accordance with example embodiments of the present disclosure. In some implementations, the design agent 320 can solve intricate design problems via hierarchical decomposition by breaking down complex tasks into manageable sub-tasks and applying multi-step reasoning to arrive at solutions that align with user intent and context. For example, the design agent 320 can decompose a high-level request for an e-commerce suite into distinct application-level, component-level, and resource-level tasks to simplify the generation process. The design agent 320 can be designed to support a multi-turn user journey, iteratively refining and customizing the design based on ongoing user interactions and feedback.

In some implementations, the design agent 320 can be designed to empower users to effectively translate their design intent into deployable application configurations, accommodating various levels of granularity. For example, the users can request overarching application infrastructure blueprints or the specifics of individual resource configurations via interfaces such as a code assist integrated development environment (IDE) 302, a cloud assist chat 304, or a design chat 306. The design agent 320 can be used for multiple different services, products, and platforms. For example, the final product of application generation can be generated in one of multiple formats (e.g., Terraform, Kubernetes YAML, and so on).

The design agent 320 can act as a toolkit, comprising a suite of tasks and tools that work in harmony to tackle user design challenges within a platform 310. In some implementations, the design agent 320 can include app design tasks 322, component design tasks 324, and resource design tasks 326. Each of these task types can be associated with specific planners, such as app design task planners 328, component design task planners 330, and resource design task planners 332. For example, an app design task planner 328 can identify the building block templates and connections required to create an initial skeleton design from a natural language prompt.

In some implementations, the design agent 320 can utilize a set of shared design tools or tool networks 340 to process multi-modal inputs. These tools can include an image-to-NL summary tool, a doc-to-NL summary tool, or a video-to-NL summary tool. For example, the design agent 320 can use an image-to-NL summary tool to translate a hand-drawn architecture sketch into a textual description that defines the required service nodes and edges.

In some implementations, the design agent 320 can include IaC generation tools or tool networks 342. These tools can provide functionality to generate configuration commands for a specific deployment environment. For example, a gcloud config generation tool network can utilize a prompt construction tool and a validator tool to produce a verified set of command line interface (CLI) commands for provisioning a cloud resource.

In some implementations, the design agent 320 can leverage a foundation layer comprising retrieval-augmented generation (RAG), Low-Rank adaptation (LoRA) fine-tuned models, and scorers 344. This layer can provide the intelligence and domain-specific context to the higher-level tasks. For example, a RAG tool can retrieve curated best practices for deployment patterns from an architecture center documentation store to help ensure the design follows enterprise standards.

In some implementations, the design agent 320 can utilize a plan classifier task to categorize the user's intent. This classification can occur at a root resolver level to determine whether the request pertains to an application, a component, or a resource. For example, the design agent 320 can classify a request to “design a high-availability database” as a component design task, triggering a specialized customization planner.

In some implementations, the design agent 320 can support iterative refinement through a feedback loop that evaluates the design across multiple dimensions. The agent can modify the design specification to improve non-functional requirements such as security, reliability, or cost. For example, if the design agent 320 identifies a requirement for DDoS protection, it can automatically attach a Cloud Armor firewall policy node to the ingress layer of the design specification.

In some implementations, the design agent 320 can implement a component parallel loop to configure multiple services simultaneously. This allows the system to generate detailed parameters for each node in a design graph in a scalable manner. For example, if an architecture includes five microservices, the design agent 320 can trigger five parallel tasks to determine the specific machine types and regions for each service.

In some implementations, the design agent 320 can facilitate cross-cloud infrastructure translation for migration use cases. The agent can ingest existing design data from a third-party system and map foreign resources to validated building blocks. For example, the design agent 320 can translate a third-party template into an intermediate design specification format before converting it into a configuration compatible with the system.

In some implementations, the design agent 320 can restrict the generation process to a library of validated building block templates. These building blocks can represent pre-approved service, workload, or asset templates that are secure by design. For example, the design agent 320 can help improve the likelihood of a secure deployment by selecting Cloud SQL templates that have regional replication and encryption enabled by default.

In some implementations, the design agent 320 can utilize a structured input requirement spec to manage user intent throughout the design lifecycle. This spec can capture multi-dimensional requirements such as performance QPS, scalability, and geographical location. For example, the design agent 320 can use this structured spec to fetch real-world resource URIs from a cloud asset inventory to populate the parameters of a VPC network node.

In some implementations, the design agent 320 can provide an embedded code diff resolver within a design interface. This allows for a human-in-the-loop review process where users can compare a suggested version of a configuration against the current version. For example, a user can review a Terraform code diff to see how a suggested change to a Cloud Run service affects traffic splitting before accepting the modification.

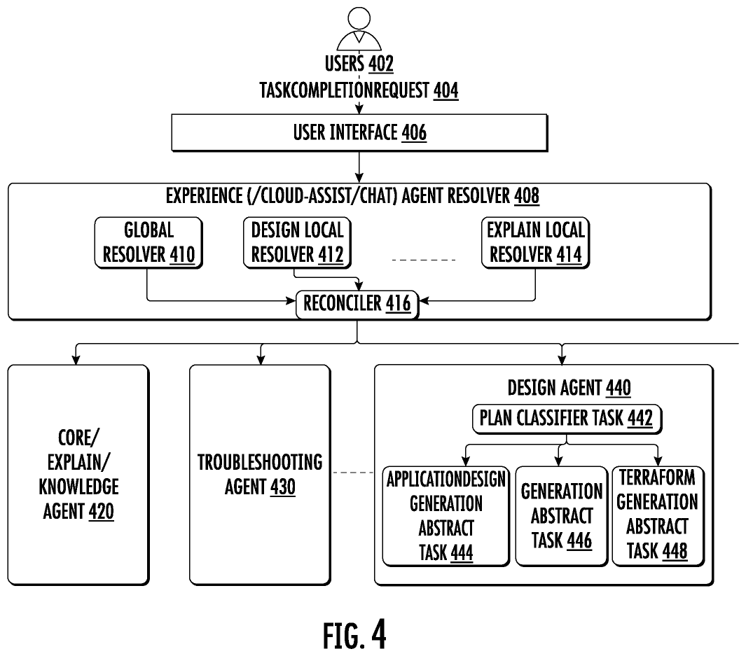

FIG. 4 represents an example application design system in accordance with example embodiments of the present disclosure. In some implementations, users 402 can initiate a task completion request 404 through a user interface 406. This interface can include various surfaces such as a code assist IDE, a cloud assist chat, or a design canvas. The user interface 406 can provide that request to an experience layer agent resolver 408. The agent resolver 408 can route requests between a global resolver 410, a design local resolver 412, and an explain local resolver 414. A reconciler 416 can coordinate the outputs from these resolvers to determine the appropriate backend agent for execution.

In some implementations, a variety of specialized agents can be utilized by the reconciler 416, including a core/explain/knowledge agent 420, a troubleshooting agent 430, and a design agent 440. Each agent can be responsible for a distinct domain of cloud management. For example, the knowledge agent 420 can provide general technical information, while the design agent 440 can focus on generating infrastructure configurations. The design agent 440 can include a plan classifier task 442 that branches into specific generation tasks. These can include an app design generation abstract task 444, a generation abstract task 446, and a terraform generation abstract task 448.

In some implementations, the design agent 440 can perform hierarchical decomposition to solve complex design problems. The agent can break down an overarching application blueprint request into smaller, manageable sub-tasks. For example, a request to design a three-tier web application can be decomposed into separate tasks for configuring a load balancer, a compute layer, and a database layer. The design agent 440 can interact with the troubleshooting agent 430 and the knowledge agent 420 as needed to enrich the design context.

In some implementations, the plan classifier task 442 can determine the appropriate output format based on user intent. This allows the system to support a variety of deployment preferences. For example, if a user specifies a preference for command-line tools, the plan classifier task 442 can trigger the generation abstract task 446. Alternatively, for users requiring infrastructure as code, the system can trigger the terraform generation abstract task 448.

In some implementations, the agent resolver 408 can utilize multi-turn reasoning to refine a design over time. The system can maintain state across multiple interactions to allow for iterative improvements. For example, a user can first request a basic web server and then, in a subsequent turn, ask to add a managed database, which the design agent 440 can incorporate into the existing specification.

In some implementations, the reconciler 416 can aggregate data from multiple agents to provide a comprehensive response. This can help improve the likelihood that the final output satisfies all aspects of a complex prompt. For example, the knowledge agent 420 can provide best practice documentation that the design agent 440 uses to configure specific parameters for a secure networking node.

In some implementations, the design agent 440 can utilize a library of validated building block templates. This ensures that the generated architecture follows secure-by-design principles. For example, instead of generating raw code, the app design generation abstract task 444 can select a pre-approved Cloud SQL template that has regional replication and encryption enabled by default.

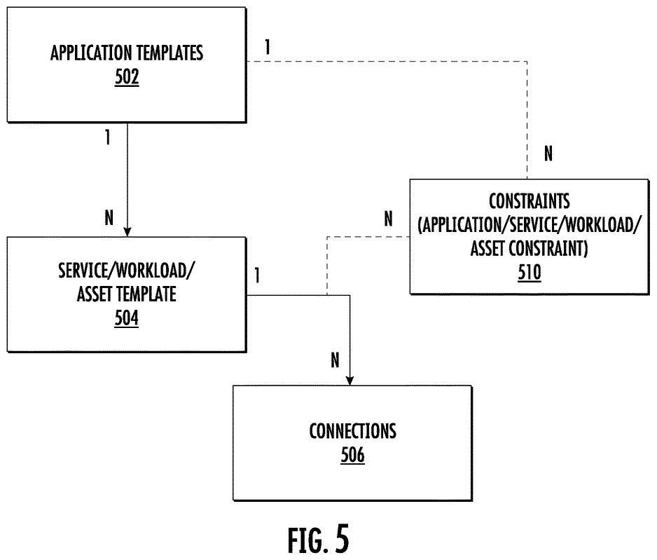

FIG. 5 represents an example application design system in accordance with example embodiments of the present disclosure. In some implementations, the design agent can provide authoring journeys to build app templates 502 from multi-modal user intent. This process can include translating images, design documents, or natural language prompts into a structured format. For example, a hand-drawn architecture sketch can be converted into a digital blueprint that defines the relationship between various cloud services.

In some implementations, the design agent can classify the design intent into one of several top-level abstract tasks that match the granularity of the intent. Upon classification, a top-level abstract task can handle the design intent by breaking down the problem into smaller design problems recursively until it finds a matching primitive task. For example, a request to design an entire e-commerce suite can land at an application design granularity, while a request for a single VM can land at a resource design granularity.

In some implementations, a task resolver can classify the intent into one of several task types. Since there is no overlap between the task types, the design task types can be classified with high predictability. Furthermore, since the design tasks are classified hierarchically, task classification can land at a particular design granularity and perform hierarchical task planning models to complete the design. For example, the system can classify a request as a component design task and then utilize a specialized customization planner to determine specific parameters for that component.

In some implementations, the system can define 1-to-N relationships between different entities in an application data model. An application template 502 can have a relationship with multiple service, workload, or asset templates 504. For example, a single application blueprint can include connections to multiple Cloud Run services and a Cloud SQL database.

In some implementations, both the application templates 502 and the individual building block templates 504 can be associated with constraints 510. These constraints 510 can represent application-centric policies or configuration requirements. For example, a constraint 510 can require that any database template selected for a production environment have automated backups and high availability enabled.

In some implementations, the service, workload, or asset templates 504 can be associated with connections 506. These connections 506 define the edges in an architecture graph and represent the traffic flow between components. For example, a connection 506 can define the networking path and protocol used between a frontend microservice and a backend search service.

In some implementations, the design agent can utilize iterative refinement to improve a design across various dimensions. The agent can modify the app template 502 based on non-functional requirements extracted from the user prompt. For example, if the user intent mentions cost optimization, the design agent can suggest replacing a high-performance VM node with a more cost-effective instance type.

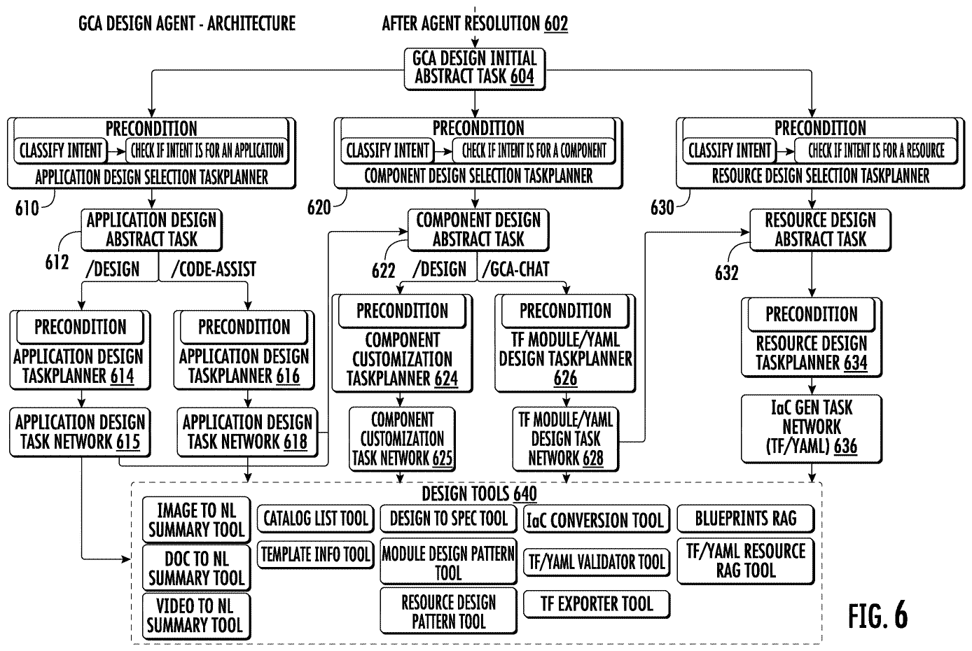

FIG. 6 represents an example architecture for a design agent in accordance with example embodiments of the present disclosure. In some implementations, the architecture can begin with a design initial abstract task 604, which follows an initial agent resolution 602. The system can utilize selection task planners 610, 620, and 630 to route the design intent into application, component, or resource design tracks. For example, a request for a real-time ingestion pipeline can land at the app design selection task planner 610.

In some implementations, the application design task 612 can be responsible for generating application templates that have associations with policies and constraints. The application design task 612 can be an abstract task that divides the application design process into a multi-step design journey which creates a design specification based on user intent and customizes over different dimensions mentioned in the user prompt. If no dimensions are supplied, the produced design specification can include best practices recommendations. The system can utilize an app design task planner 616 to generate a corresponding app design task network 618 to execute these steps.

In some implementations, the design agent can receive a request to design an application with three microservices and an external load balancer that operates in a single region and serves 10,000 QPS. The system can break this down into specific sub-tasks within a application design task network 615, which is generated by an application design task planner 614. For example, the task network 615 can include parallel tasks for configuring each of the three microservices based on their individual database and cache requirements.

In some implementations, a request can include designing an application which creates embeddings from storage data and provides a generative AI chatbot application using the content. The system can utilize an app design task planner 614 to identify the building blocks such as Vertex AI endpoints and Cloud Storage buckets. For example, the planner can determine that the backend service requires a connection to a PostgreSQL database with a vector extension.

In some implementations, the request can be to design a real-time ingestion pipeline that collects events across multiple regions and saves the events in a data warehouse in one region. The input can include a natural language prompt, image data, video data, and so on. The output can include an API spec, Terraform, or YAML. For example, the design agent can convert an architecture diagram image into a design specification that defines a Pub/Sub topic connected to a Dataflow job.

In some implementations, the design agent can perform a component design task 622. The component can be a service, a workload, or an asset. The component design task 622 can be a sub-task under application design or a standalone task. Components can include services like Cloud SQL, workloads like a managed instance group (MIG), or infrastructure types like a VPC or a cluster. A component can be backed by a building block template. To handle these components, the system may employ a component customization task planner 624 or a YAML design task planner 626. The latter can generate a YAML design task network 628 specifically for chat interactions.

In some implementations, the component design abstract task 622 can use enterprise blueprints to help accomplish the task. This task can have some overlap with the resource design task 632. In some examples, users can prefer to generate regular Terraform code, but in some cases, it can be beneficial to provide a response using enterprise blueprints. For example, the system can utilize a pre-authored blueprint for a secure GKE cluster instead of generating the resource configurations from scratch.

In some implementations, the component design task 622 can also be a top-level abstract task for certain complex use cases. The design agent can choose criteria between the resource design task and the component design task based on Terraform or YAML module availability. Designing a component can involve a fixed set of steps to map the intent into pre-authored modules and customize the module parameters. For example, the system can map a request for a web hosting workload to a specific MIG template and then customize the instance type and region.

In some implementations, setting the parameters or customizing the module can occur with respect to various dimensions supplied by user intent. If no pre-authored module is available, the component design task 622 can break down the problem into a set of resource creation steps and use the resource design task 632 to accomplish them. For example, the system can decompose a custom firewall requirement into individual resource creation tasks for multiple commands.

In some implementations, examples of components can include a request to design a managed instance group that can handle 10,000 requests per second in a specific region with two zones of availability. Another example can include a request to design an external load balancer for an API serving workload. The design agent can utilize a component customization task network 625 to determine the correct configuration. For example, the system can recommend a C2 compute-optimized VM family based on the high-performance requirement.

In some implementations, a component design task can include a request to design a database in one region with replication for disaster recovery in another region. The input can include a natural language prompt, an image, a video, or other visual media. The output can include an API spec, a design specification, gcloud, Terraform, or YAML. For example, the system can generate a design specification that specifies a primary PostgreSQL node in us-west1 and a replica node in us-west2.

In some implementations, the design agent can perform a design resource task 632. Designing a resource can be the lowest level design intent which maps to a resource design abstract task. Generally, there can be more than one way to provision these resources. Based on user input, this task can classify the IaC generation request into Terraform, gcloud, or YAML. For example, a user requesting “commands for a storage bucket” can trigger a specific resource design task planner 634.

In some implementations, the design agent performing the resource design task 632 can choose different task plans based on whether the intent is to create or update a resource. The system can utilize domain-specific tools, such as a role finder or an organization policy generator, to build additional context. For example, if a user asks to make a bucket IL4 compliant, the system can first identify the organization policies before generating the configuration.

In some implementations, examples of resource design can include a request to create a low-cost VM or to generate Terraform code to set up organization policies on storage that satisfy compliance guidelines. The system can utilize an IaC generation task network 636 to produce the final code. For example, the design agent can generate resource-manager commands to enforce encryption and restrict public access on a bucket.

In some implementations, the design agent can solve design problems using multiple abstract tasks and shared design tools 640. It can be beneficial to carry the internal state from one tool or task to another without losing information. These design tasks can iterate over the design to improve and customize the solution based on project context. For example, the system can use a catalog list tool to identify available templates before passing that list to a selection planner.

In some implementations, the design agent can represent the internal state as a design specification in a YAML or JSON format. This intermediate representation is often easier for multi-component design generation than raw code. The design specification can represent the application as a graph where each node represents a cloud product and each edge represents connectivity. For example, a design graph can show a load balancer node connected to a web-layer node, with each node containing configuration key-value pairs.

In some implementations, the design agent can convert the design specification to a final format based on the target surface. The last step in the planner can translate the intermediate graph into an API specification or Terraform code. For example, the system can utilize a conversion tool to turn a YAML-based blueprint into a deployable application template that automatically registers services with a management hub.

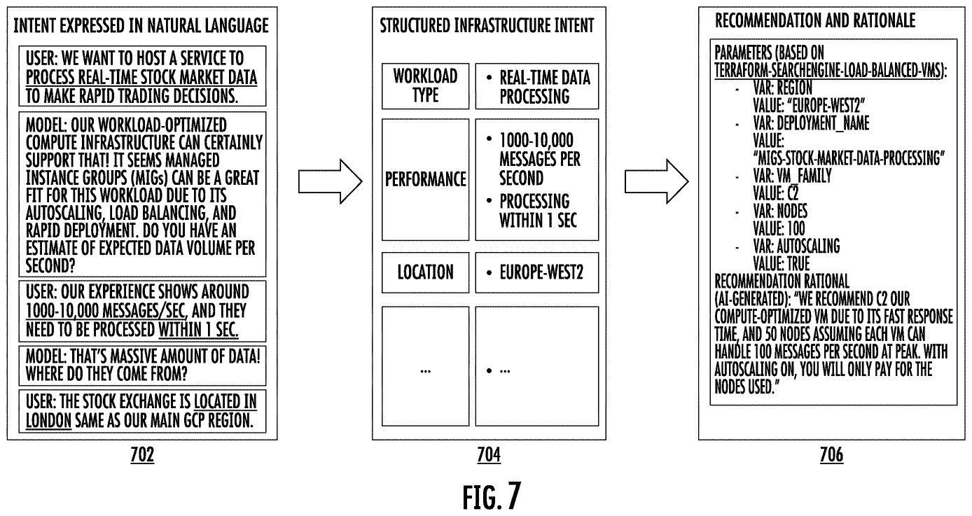

FIG. 7 represents a process for inputting user requirements into the application design system in accordance with example embodiments of the present disclosure. In some implementations, an intent expressed in natural language 702 is converted into a structured infrastructure intent 704. This structured intent 704 can be a structured representation of user intent that is used to send requirements between various tasks and tools. For example, a chat dialogue regarding hosting a stock market data service can be parsed into a table that defines the workload type and performance needs.

In some implementations, the construction of this specification can utilize a parameter extraction tool. This structured spec can include resource URI mapping to the parameters. For example, if a user specifies to use a particular VPC network, the system can store that network name as a parameter and lookup the actual VPC URI using a cloud asset inventory extension tool. This can help improve the likelihood that the final design is compatible with the user's existing environment.

In some implementations, the system can provide a recommendation and rationale 706 based on the structured intent 704. This can include specific technical parameters and a human-readable explanation of why those choices were made. For example, the system can recommend a C2 compute-optimized VM family and explain that this choice was made to satisfy the user's requirement for processing 10,000 messages per second.

In some implementations, a rule-based recommendation can help to provide deterministic configurations for the user. The system can utilize a rule set to improve product selection and parameter values. For example, a rule can specify that for high-availability workloads, the system should automatically suggest a multi-zone configuration for the compute tier.

In some implementations, recommendations based on the structured input requirement can be used in the task planner as part of customizing the components in an application design. The system can combine LLM reasoning with these rules to provide both flexible and reliable designs. For example, the system can use LLM inference to identify the services and then apply a rule-based suggestion to set the correct disk type for a database node.

In some implementations, the structured intent 704 can include multiple dimensions such as performance, scalability, availability, and security. The system can translate the natural language intent into these specific requirements to guide the subsequent design tasks. For example, if a user mentions “bursty traffic,” the system can extract a requirement for fast auto-scaling in the structured specification.

In some implementations, the process can involve building a user context to enhance the prompt. This can include fetching existing resource information to ensure the new design integrates seamlessly with the user's cloud project. For example, the system can identify an existing subnet range and include it as a constraint in the structured infrastructure intent.

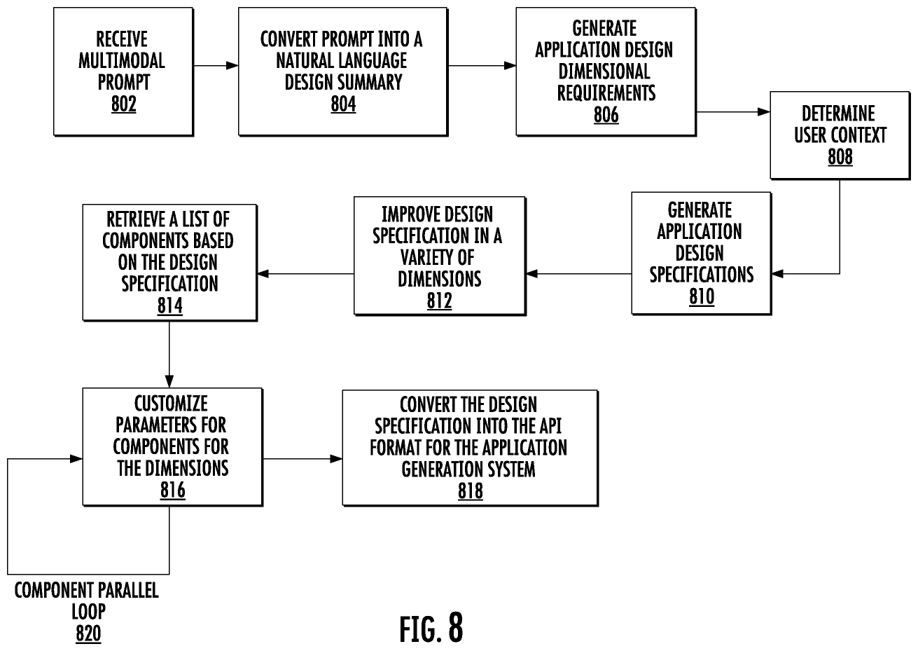

FIG. 8 represents a process for generating an application in accordance with example embodiments of the present disclosure. In some implementations, the application generation system can, at 802, receive a multi-modal prompt. The multi-modal prompt can include a variety of input types, such as natural language text, architectural diagrams, or design documents. For example, a user can provide a hand-drawn sketch of a microservices architecture to initiate the design process.

In some implementations, the application generation system can, at 804, convert the multi-modal prompt into a natural language design summary. This step can involve utilizing a vision-language model to interpret visual elements and spatial relationships in an architecture diagram and translate them into a descriptive text format. For example, the system can identify that a box labeled “Gateway” is connected to three other boxes and summarize this as an ingress layer routing to three downstream microservices.

In some implementations, the application generation system can, at 806, generate application design dimensional requirements. These requirements can be extracted from the natural language design summary to form a structured input requirement specification. For example, the system can identify specific performance targets, such as a requirement for 10,000 transactions per second, and record this in a structured table of design constraints.

In some implementations, the application generation system can, at 808, determine a user context. Determining the context can involve identifying existing cloud resources, organizational policies, or available building block service templates within a specific user workspace. For example, the system can perform a lookup of a user's virtual private cloud (VPC) configurations via a cloud asset inventory to ensure the new application design integrates with the existing network infrastructure.

In some implementations, the application generation system can, at 810, generate application design specifications. The design specification can be an intermediate, graph-based representation, such as a design specification, that identifies the service components and their logical connections. For example, the system can generate a YAML-formatted graph consisting of nodes for a load balancer and a web server, connected by a directed edge representing traffic flow.

In some implementations, the application generation system can, at 812, improve the design specification in a variety of dimensions. Improvements can be applied iteratively to enhance the design's security, reliability, or cost-effectiveness based on determined best practices and rule-based additions. For example, the system can automatically attach a Cloud Armor firewall policy node to a load balancer node if the initial requirements specify a need for DDoS protection.

In some implementations, the application generation system can, at 814, retrieve a list of components based on the design specification. This step can involve mapping the generic nodes in the design specification to specific, validated building block templates from a service catalog. For example, a generic “database” node can be associated with a specific template that has been pre-approved for enterprise use.

In some implementations, the application generation system can, at 816, customize parameters for components for the dimensions. This customization can involve setting specific technical values for each component node, such as machine types, regions, or storage sizes, to align with the dimensional requirements. For example, a compute node can be configured with a high-memory C2 machine type to satisfy a specific performance dimension identified in the structured requirement specification.

In some implementations, the application generation system can, at 820, utilize a component parallel loop to perform the customization step for multiple components simultaneously. Utilizing a parallel loop can improve the efficiency of the design process by allowing independent services to be configured as a task network without waiting for others to complete. For example, the system can concurrently determine the configuration settings for five different microservices within a single architectural design specification.

In some implementations, the application generation system can, at 818, convert the design specification into an API format. The final conversion can transform the intermediate design specification into a deployable format (e.g., Terraform, Kubernetes YAML, gcloud, or a specific API specification). For example, the completed design specification can be exported as a set of Terraform files that automatically register workload and service assets with a management hub.

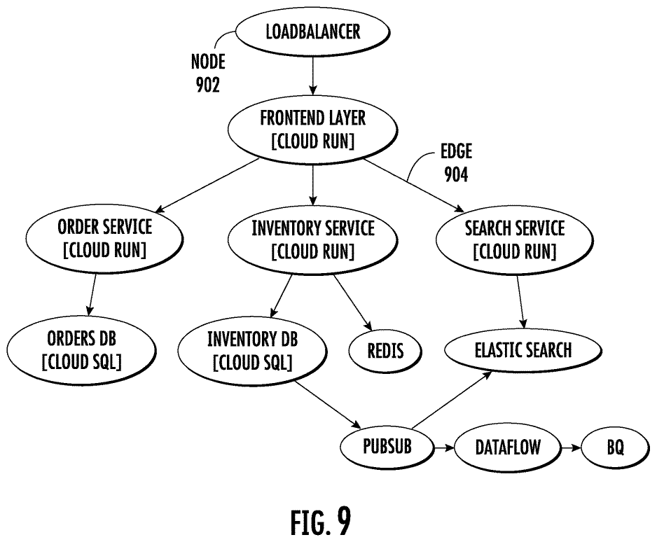

FIG. 9 depicts a block diagram of an architectural graph in accordance with example embodiments of the present disclosure. In some implementations, the graph can include a plurality of nodes 902 and edges 904 representing the topology of a cloud application. For example, a node 902 can represent a service, while an edge 904 can represent the networking path through which that service communicates with a backend database.

The graph can include an ingress layer, such as a LoadBalancer node. The LoadBalancer node can serve as the primary entry point for external traffic and can be connected to downstream compute resources. For example, the LoadBalancer can be configured to distribute incoming HTTPS requests across a fleet of frontend instances to improve availability.

The graph can include a compute layer, such as a Frontend Layer node implemented via Cloud Run. This node 902 can represent the user-facing portion of the application that processes incoming requests and coordinates with backend services. For example, the Frontend Layer can host a web interface that communicates with various microservices to fulfill user transactions.

The graph can include a service layer consisting of multiple microservice nodes, such as an Order Service, an Inventory Service, and a Search Service. Each service node can be responsible for a distinct business function within the application architecture. For example, the Order Service can handle checkout logic, while the Inventory Service manages product availability data.

The graph can include a data persistence layer, such as an Orders DB node and an Inventory DB node. These nodes 902 can be connected to their respective service nodes to provide long-term data storage. For example, the Orders DB node can represent a PostgreSQL database where customer transaction records are stored and managed.

The graph can include a caching layer, such as a redis node. The redis node can be connected to a service node to provide low-latency data access and improve overall application performance. For example, the Inventory Service can utilize the redis node to cache frequently accessed product details, thereby reducing the load on the primary Inventory DB.

The graph can include an analytics and search layer, such as an Elastic Search node. This node 902 can be connected to a search-focused service node to enable complex querying capabilities. For example, the Search Service can utilize the Elastic Search node to provide users with fast and relevant results when they browse a product catalog.

The graph can include an asynchronous processing layer, such as a pubsub node, a dataflow node, and a bq node. These nodes 902 can be connected in a sequence to handle event-driven data pipelines and large-scale data warehousing. For example, changelog events from the Inventory DB can flow through the pubsub node to a dataflow node for processing before being stored in the bq node for historical analysis.

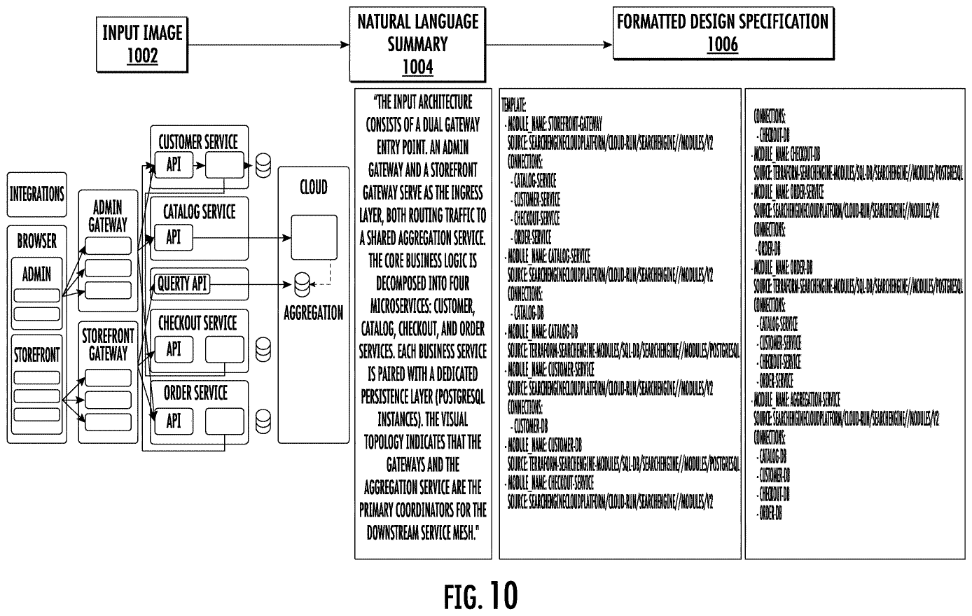

FIG. 10 is a block diagram of an example processing flow for transforming an input image into a formatted design specification in accordance with example embodiments of the present disclosure. In some implementations, the system can, at 1002, receive an input image. The input image 1002 can be a visual representation of an infrastructure architecture, such as a digital diagram or a hand-drawn sketch. For example, the image can show several boxes representing services connected by arrows representing data flow.

In some implementations, the system can, at 1004, generate a natural language summary of the input image 1002. The natural language summary 1004 can provide a textual description of the components and structural relationships identified within the visual input. For example, for a hand-drawn architecture sketch, the summary can describe a dual-gateway entry point consisting of an Admin Gateway and a Storefront Gateway that route traffic to a shared Aggregation Service and several backend microservices, such as Customer, Catalog, Checkout, and Order services.

In some implementations, the system can, at 1006, generate a formatted design specification based on the natural language summary 1004. The formatted design specification 1006 can be a machine-readable intermediate representation, such as a YAML or JSON template. For example, the specification can include a list of modules where each module name corresponds to a service described in the summary, and each connection reflects a logical relationship identified in the original image.

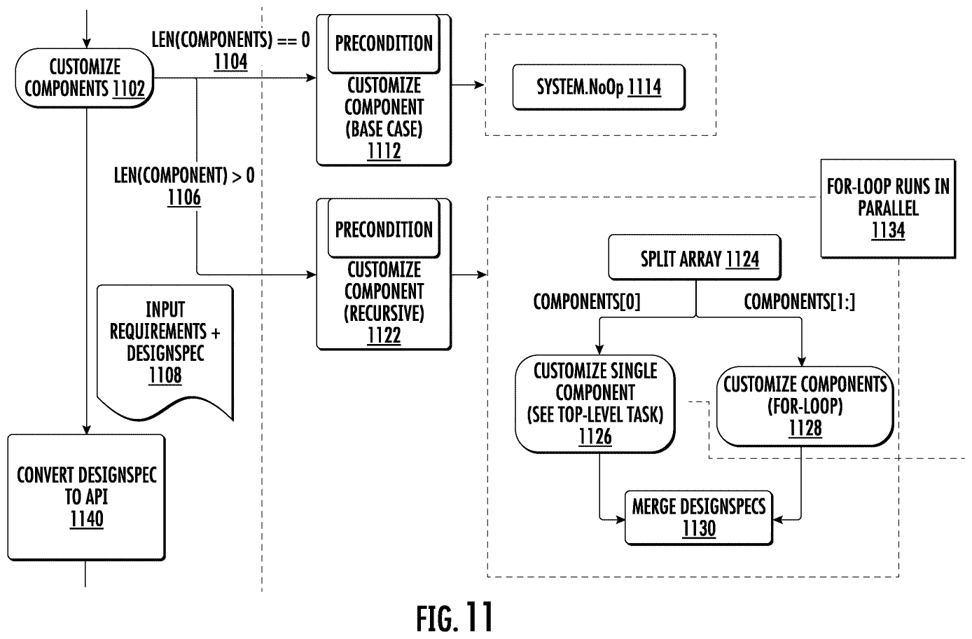

FIG. 11 is a block diagram illustrating the logic for a recursive component customization process in accordance with example embodiments of the present disclosure. In some implementations, the system can, at 1102, initiate a task to customize components within a design specification. The process can utilize a recursive strategy to handle varying numbers of components. For example, the system can determine whether to process a single component or to split a larger set of components for simultaneous configuration.

In some implementations, the system can, at 1104, identify a base case where the number of components is zero. In this scenario, the system can, at 1112, perform a base case customization, which can lead to a system NoOp 1114, as there are no further components to configure. For example, this base case can be reached at the end of a recursive loop once every service in the design has been processed.

In some implementations, the system can, at 1106, identify a recursive case where the number of components is greater than zero. In this case, the system can, at 1122, perform a recursive customization of components. This process can, at 1108, utilize input requirements and the design specification to perform further customization. For example, the system can use extracted performance requirements to guide the parameter selection for the remaining components in the list.

In some implementations, the system can, at 1124, perform a split array operation. The split array operation can divide a list of components into a single component for immediate processing and a remainder list for parallel execution. For example, the system can take the first component from a list of ten and send the remaining nine to a parallel processing network.

In some implementations, the system can, at 1126, customize a single component. This step can involve applying specific configuration logic to one service node at a time. For example, the system can determine the regional settings and machine type for a single frontend service node based on the user intent.

In some implementations, the system can, at 1128, customize components through a parallel for-loop. In some implementations, the system can, at 1134, ensure the for-loop runs in parallel. This allows multiple components to be configured at the same time, which can improve the overall speed of the design generation process. For example, while one task configures a database, several other tasks can simultaneously configure multiple microservice nodes.

In some implementations, the system can, at 1130, merge design specifications. The merge operation can combine the configuration data from individually processed components back into a single, unified design specification. For example, once the parallel tasks have completed, their respective outputs are integrated into the primary design graph to form a complete architectural blueprint.

In some implementations, the system can, at 1140, convert the design specification to an API format. The finalized, merged design specification can be transformed into the target format required for deployment or further review. For example, the system can output a serialized application template that can be loaded into a design canvas for a human-in-the-loop review.

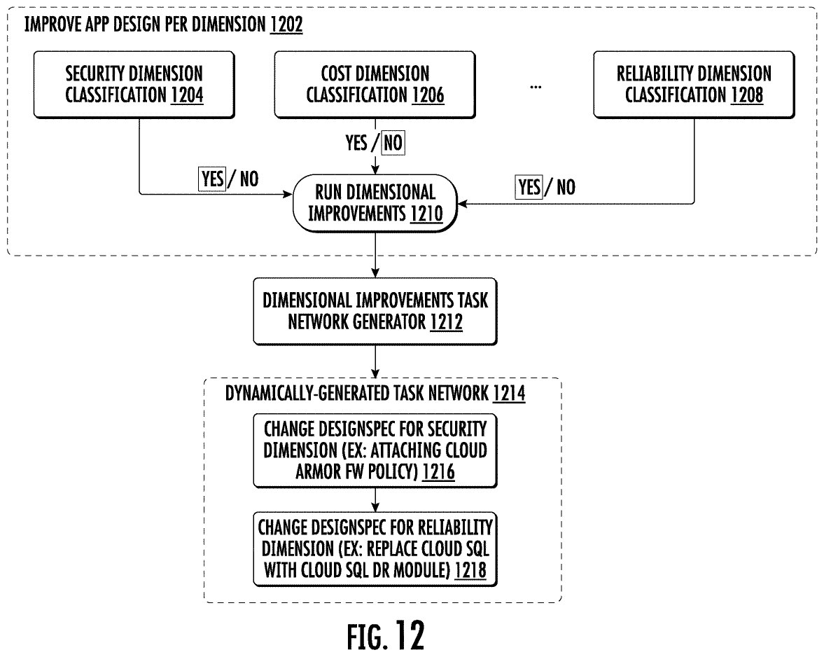

FIG. 12 is a block diagram illustrating a process for improving an application design across various dimensions in accordance with example embodiments of the present disclosure. In some implementations, the system can, at 1202, initiate a process to improve the application design per dimension. The process can categorize design improvements into distinct functional areas. For example, the system can evaluate the design's posture across security, cost, and reliability dimensions.

In some implementations, the system can, at 1204, 1206, and 1208, perform dimension classification for security, cost, and reliability, respectively. These classifications can determine whether the current design meets the desired standards for each area. For example, the reliability dimension classification 1208 can check if the design includes sufficient redundancy to meet a user's high-availability requirements.

In some implementations, the system can, at 1210, perform a decision step to run dimensional improvements. If the system determines that the design can be enhanced, it can trigger an improvement generator. For example, if the security classification reveals a lack of ingress protection, the system can decide to apply a security-focused modification to the design.

In some implementations, the system can, at 1212, utilize a dimensional improvements task network generator. This generator can create a specialized set of tasks designed to address the identified gaps in the design. For example, the generator can produce a task network specifically focused on adding cost-optimization features to the existing architecture.

In some implementations, the system can, at 1214, execute a dynamically-generated task network. This task network can apply specific changes to the design specification in a targeted manner. For example, the network can perform a rule-based modification to the design graph without requiring a full rewrite of the infrastructure specification.

In some implementations, the system can, at 1216, change the design specification for a security dimension. This can include adding or modifying nodes to improve the application's security posture. For example, the system can attach a Cloud Armor firewall policy node to a load balancer node to protect the application from external threats.

In some implementations, the system can, at 1218, change the design specification for a reliability dimension. These changes can improve the design's ability to handle failures or traffic spikes. For example, the system can replace a standard database module with a disaster recovery (DR) module that includes cross-region replication.

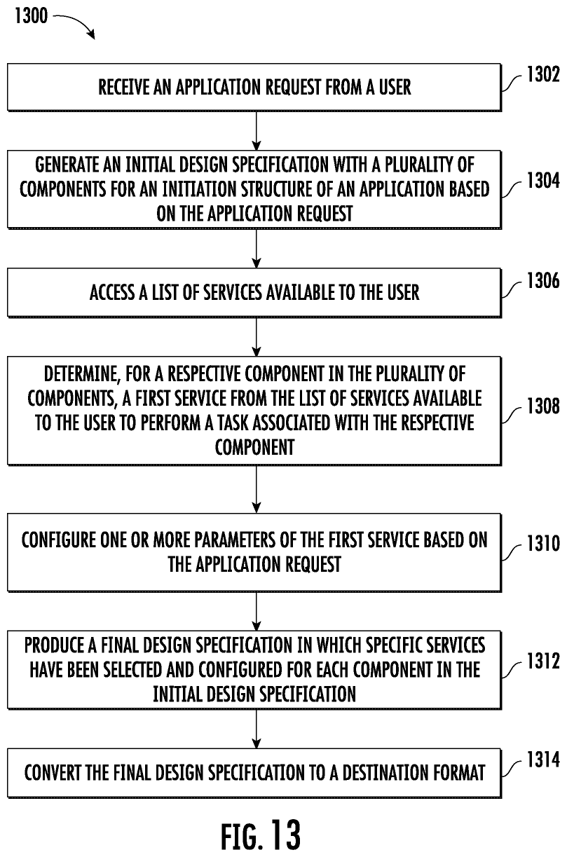

FIG. 13 is a flow diagram 1300 illustrating an example method for application design in accordance with example embodiments of the present disclosure. The application design system can, at 1302, receive an application request from a user. In some implementations, the request can include a multi-modal request that includes text images. For example, the multi-modal request can include as a natural language description, a design document, or an architecture diagram image. For example, a user can provide a hand-drawn sketch of a microservices architecture to initiate the design process. In some implementations, the system can convert the multi-modal prompt into a natural language design summary. This can include identifying spatial relationships in a diagram and translating them into logical edges in a design graph.

The application design system can, at 1304, generate, using a machine-learned model, an initial design specification with a plurality of components for an initial structure of an application based on the application request. In some implementations, the machine-learned model can be a design agent. In some implementations, the initial design specification comprises an intermediate representation of a design graph structured with a plurality of nodes and edges. Each node can represent a service component that performs a specific task, and each edge can represent connections between service components. In some implementations, the system can determine one or more user intents based on the application request and determine components for the initial design specification based on those intents. For example, the system can extract specific performance requirements, such as 10,000 queries per second, to guide the initial selection of component types. In some implementations, generating the initial design specification can include performing hierarchical task decomposition to break the application request into a plurality of sub-tasks, such as application-level, component-level, and resource-level tasks. In some implementations, the system can determine an application type, select a template based on that type, and update the template based on the request. For example, the system can select a three-tier web application template and modify it to include additional messaging components requested by the user.

In some implementations, the initial design specification can be generated by selecting from a library of validated building blocks pre-configured for security and compliance. For example, the system can select from pre-approved service, workload, or asset templates that are governed by enterprise constraints. In some implementations, the application request can include existing infrastructure patterns from a third-party cloud provider, such as AWS CloudFormation or Azure templates, and generating the initial design specification can include translating these patterns into the intermediate representation. For example, the system can map vendor-specific triggers to corresponding service components in a different cloud environment. In some implementations, the design agent can provide the initial design specification to the user for display. In some implementations, the design agent can provide a request for feedback to the user. The user can, using input tools at the user computing device provide feedback. The design agent can receive user feedback.

The application design system can, at 1306, access a list of services available to the user. In some implementations, the system can access a user profile to determine which services the user has permission to access. For example, the system can identify a list of permitted cloud products and building block templates associated with the user's organizational account.

The application design system can, at 1308, determine, for a respective component in the plurality of components, a first service from the list of services available to the user to perform a task associated with the respective component. In some implementations, the first service is selected based on the task associated with the component and the determined user intents. For example, if a component is tasked with providing a database, the system can select a specific Cloud SQL service from the available list that supports the required database engine.

The application design system can, at 1310, configure one or more parameters of the first service based on the application request. In some implementations, the parameters can be retrieved from a knowledge base, such as a documentation store containing building block template schemas and best practices. In some implementations, the parameters are configured based on the determined user intents. For example, a database service can be configured for high availability by setting regional availability types and SSD disk types based on user performance requirements. In some implementations, the system can determine a user context, such as existing virtual private cloud configurations, to ensure the parameters are compatible with the user's existing environment.

The application design system can, at 1312, produce a final design specification in which specific services have been selected and configured for each component in the initial design specification. In some implementations, the design agent can provide feedback to update the design specification. For example, the feedback can be generated based on a rules-based evaluation to improve the design across dimensions such as security, reliability, or cost. If the user intent indicates a need for DDoS protection, the design agent can automatically attach a firewall policy node to a load balancer node in the final design specification.

The application design system can, at 1314, convert the final design specification to a destination format. In some implementations, the destination format is determined based on the application request or supplemental information about the user, such as a preferred IaC language. In some implementations, the converted document can then be transmitted to the user for deployment.

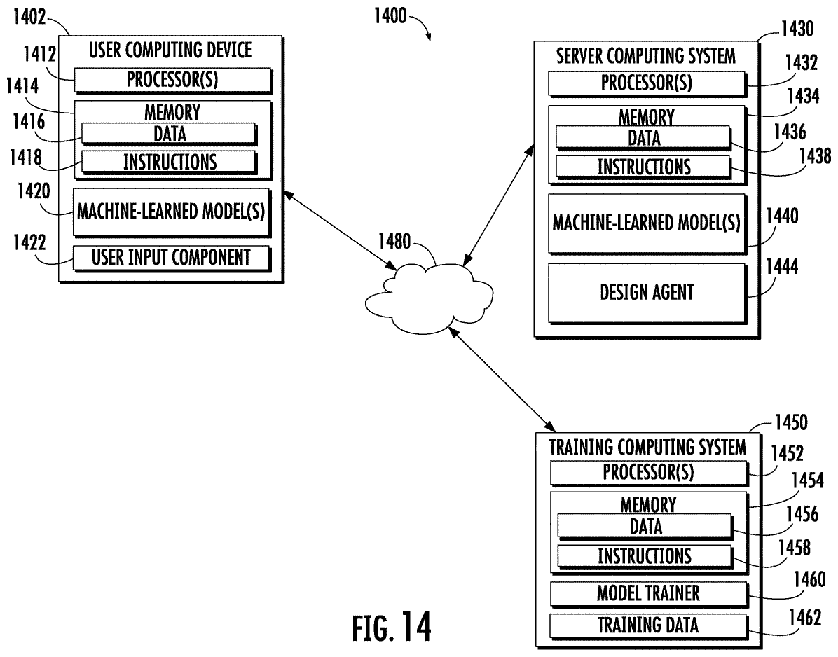

FIG. 14 depicts a block diagram of an example user computing system 1400 for generating application structures according to example embodiments of the present disclosure. In some implementations, the system 1400 can include a hierarchical task decomposition framework that classifies user intent to generate complex infrastructure designs. The computing system 1400 includes a user computing device 1402, a server computing system 1430, and a training computing system 1450 that are communicatively coupled over a network 1480.

The user computing device 1402 can be any type of computing device, such as a personal computing device (e.g., laptop or desktop), a mobile computing device (e.g., smartphone or tablet), a gaming console or controller, a wearable computing device, an embedded computing device, or any other type of computing device. In some implementations, the user computing device 1402 can provide various surfaces for interaction, such as a code assist interface or a design canvas.

The user computing device 1402 includes one or more processors 1412 and a memory 1414. The one or more processors 1412 can be any suitable processing device (e.g., a processor core, a microprocessor, an ASIC, an FPGA, a controller, a microcontroller, etc.). The one or more processors 1412 can be one processor or a plurality of processors that are operatively connected. The memory 1414 can include one or more non-transitory computer-readable storage mediums, such as RAM, ROM, EEPROM, EPROM, flash memory devices, magnetic disks, etc., and combinations thereof. The memory 1414 can store data 1416 and instructions 1418, which are executed by the processor 1412 to cause the user computing device 1402 to perform operations. The user computing device can also include one or more user input components 1422.

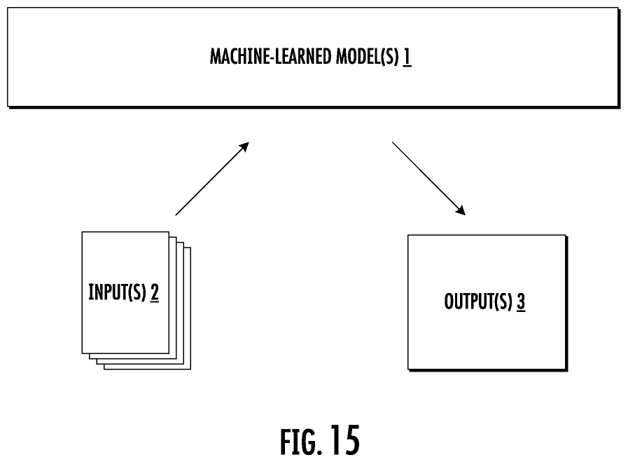

In some implementations, the user computing device 1402 can store or include one or more machine-learned models 1420 (e.g., a query suggestion model, a teaching model, a query response model, and so on). For example, the machine-learned models 1420 can or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, or other forms of neural networks. Example machine-learned models 1420 are discussed with reference to FIGS. 15-19.

In some implementations, the one or more machine-learned models 1420 can be received from a server computing system 1430 over network 1480, stored in the memory 1414 of the user computing device 1402, and then used or otherwise implemented by the one or more processors 1412. In some implementations, the user computing device 1402 can implement multiple parallel instances of a single machine-learned model 1420. The machine-learned model 1420 (e.g., a sequence processing model) can generate application structures in response to user requests, for instance, by translating a natural language design intent into a structured design specification.

The server computing system 1430 includes one or more processors 1432 and a memory 1434. The one or more processors 1432 can be any suitable processing device (e.g., a processor core, a microprocessor, an ASIC, an FPGA, a controller, a microcontroller, etc.) and can be one processor or a plurality of processors that are operatively connected. The memory 1434 can include one or more non-transitory computer-readable storage mediums, such as RAM, ROM, EEPROM, EPROM, flash memory devices, magnetic disks, etc., and combinations thereof. The memory 1434 can store data 1436 and instructions 1438, which are executed by the processor 1432 to cause the server computing system 1430 to perform operations.

In some implementations, the server computing system 1430 includes or is otherwise implemented by one or more server computing devices. In instances in which server computing system 1430 includes plural server computing devices, such server computing devices can operate according to sequential computing architectures, parallel computing architectures, or some combination thereof.

As described above, the server computing system 1430 can store or otherwise include one or more machine-learned models 1440 (e.g., a sequence processing model). For example, the models 1440 can be or can otherwise include various machine-learned models. Examples of machine-learned models include neural networks or other multi-layer non-linear models. Example neural networks include feed forward neural networks, deep neural networks, recurrent neural networks, and convolutional neural networks. Example models 1440 are discussed with reference to FIGS. 15-19.

The server computing system 1430 also includes a design agent 1444. In some implementations, the design agent 1444 can manage the conversion of multi-modal prompts into deployable configurations. The user computing device 1402 and/or a server computing system 1430 can train the models 1420 and/or 1440 via interaction with the training computing system 1450, which is communicatively coupled over the network 1480. The training computing system 1450 can be separate from or a portion of the server computing system 1430.

The training computing system 1450 includes one or more processors 1452 and a memory 1454. The one or more processors 1452 can be any suitable processing device (e.g., a processor core, a microprocessor, an ASIC, an FPGA, a controller, a microcontroller, etc.) and can be one processor or a plurality of processors that are operatively connected. The memory 1454 can include one or more non-transitory computer-readable storage mediums, such as RAM, ROM, EEPROM, EPROM, flash memory devices, magnetic disks, etc., and combinations thereof. The memory 1454 can store data 1456 and instructions 1458 which are executed by the processor 1452 to cause the training computing system 1450 to perform operations. In some implementations, the training computing system 1450 includes or is otherwise implemented by one or more server computing devices.

The training computing system 1450 can include a model trainer 1460 that trains the machine-learned models 1420 and/or 1440 stored at the user computing device 1402 and/or the server computing system 1430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to update the parameters over a number of training iterations iteratively.

In some implementations, performing backwards propagation of errors can include performing truncated backpropagation through time. The model trainer 1460 can perform a number of generalization techniques (e.g., weight decays, dropouts, etc.) to improve the generalization capability of the models being trained.

The network 1480 can be any type of communications network, such as a local area network (e.g., intranet), wide area network (e.g., Internet), or some combination thereof and can include any number of wired or wireless links. In general, communication over the network 1480 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 14 illustrates an example computing system that can be used to implement the present disclosure. Other computing systems can be used as well. For example, in some implementations, the user computing device 1402 can include the model trainer 1460 and the training data 1462. In such implementations, the model(s) 1420 can be trained and used locally at the user computing device 1402. In some implementations, the user computing device 1402 can implement the model trainer 1460 to personalize the model(s) 1420 based on user-specific data, such as a preferred service catalog or organizational best practices.

FIG. 15 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of a message generation model. Although various features, variations, and implementations described below are described with respect to machine-learned model(s) 1, it is to be understood that such features, variations, and implementations are to be understood as described with respect to the message generation model, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

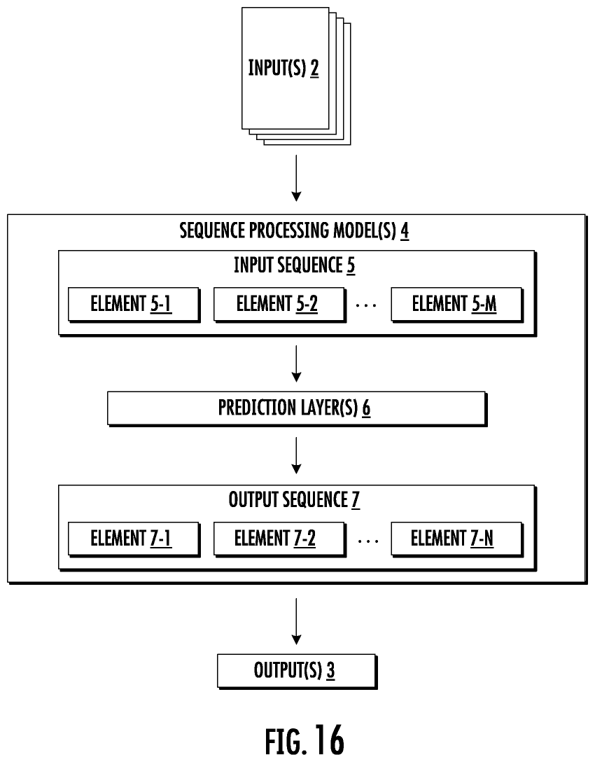

FIG. 16 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2,. 5-M, etc. obtained from input(s) 2. Sequence processing model 4 can process input sequence 5 using prediction layer(s) 6 to generate an output sequence 7. Output sequence 7 can include one or more output elements 7-1, 7-2,. 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 15 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2,. 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

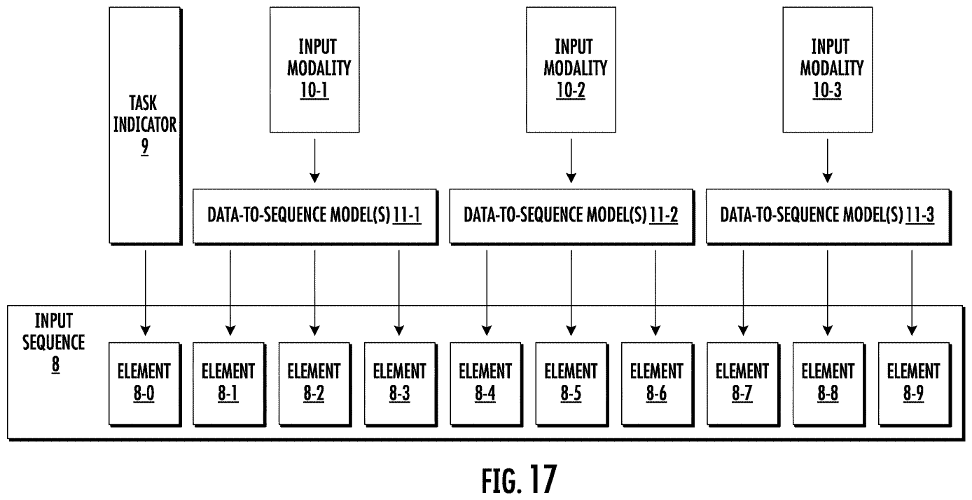

FIG. 17 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

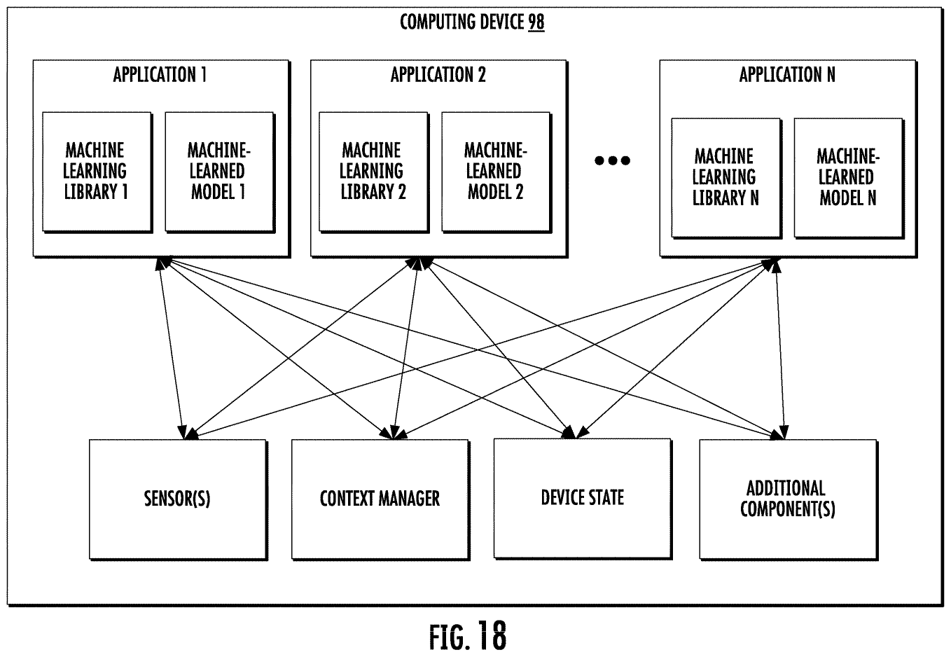

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine-learned library and machine-learned model(s). For example, each application can include a machine-learned model. Example applications include a text messaging application, an email application, a dictation application, a virtual keyboard application, a browser application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

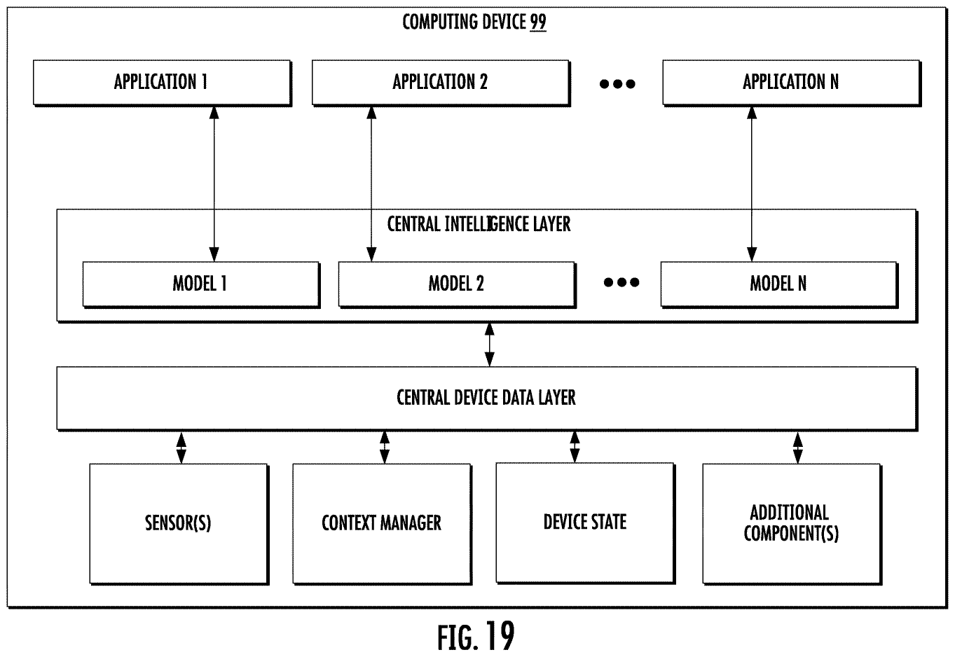

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, the method comprising:
receiving, by a computing system with one or more processors, an application request from a user;
generating, by a machine-learned model implemented by the computing system, an initial design specification with a plurality of components for a structure of an application based on the application request, wherein the initial design specification comprises an intermediate representation of a design graph;
accessing, by the computing system, a list of services available to the user;
determining, by the computing system, for a respective component in the plurality of components, a first service from the list of services available to the user to perform a task associated with the respective component;
configuring, by the computing system, one or more parameters of the first service based on the application request;
producing, by the computing system, a final design specification in which specific services have been selected and configured for each component in the initial design specification; and
converting, by the computing system, the final design specification to a destination format.

2. The computer-implemented method of claim 1, wherein the initial design specification is represented as a graph with a plurality of nodes and a plurality of edges, wherein each node represents a component that performs a specific task, and each edge represents connections between components.

3. The computer-implemented method of claim 2, wherein the one or more parameters for the first service are retrieved from a knowledge base.

4. The computer-implemented method of claim 1, wherein the application request is described in natural language.

5. The computer-implemented method of claim 1, wherein the application request is a multimodal request and includes one or more images.

6. The computer-implemented method of claim 5, further comprising converting, by the computing system, the multimodal request into a natural language description.

7. The computer-implemented method of claim 1, further comprising:
determining, by the computing system, one or more user intents based on the application request; and
determining one or more components and a task associated with the components for the initial design specification based on the determined one or more user intents.

8. The computer-implemented method of claim 7, wherein the first service is selected for the respective component based, at least in part, on the task associated with the component and the one or more user intents.

9. The computer-implemented method of claim 7, wherein the one or more parameters of the first service are configured based on the one or more user intents.

10. The computer-implemented method of claim 1, wherein the machine-learned model includes a design agent.

11. The computer-implemented method of claim 10, further comprising:
providing, by the computing system, the initial design specification to the design agent;
receiving, by the computing system, feedback from the design agent; and
updating, by the computing system, the initial design specification based on the feedback from the design agent.

12. The computer-implemented method of claim 11, wherein the feedback from the design agent is generated based on a rules-based evaluation performed by the design agent to improve the initial design specification across a plurality of dimensions.

13. The computer-implemented method of claim 1, further comprising:
providing, by the computing system, the initial design specification for display to the user;
providing, by the computing system, a request for feedback to the user; and
receiving, by the computing system, user feedback for the initial design specification.

14. The computer-implemented method of claim 1, wherein the destination format is determined based on the application request or supplemental information about the user.

15. The computer-implemented method of claim 1, wherein generating the initial design specification further comprises:
determining, by the computing system, an application type based on the application request;
selecting, by the computing system, a template based on the application type; and
updating, by the computing system, the template based on the application request.

16. The computer-implemented method of claim 1, wherein generating the initial design specification further comprises performing hierarchical task decomposition to break the application request into a plurality of sub-tasks.

17. The computer-implemented method of claim 1, wherein the initial design specification is generated by selecting from a library of validated building blocks pre-configured for security and compliance.

18. The computer-implemented method of claim 1, wherein the application request comprises existing infrastructure patterns from a third-party cloud provider, and wherein generating the initial design specification comprises translating the patterns into the intermediate representation.

19. A computing system comprising one or more processors and one or more non-transitory computer-readable media storing instructions that are executable by one or more processors to cause the computing system to perform operations, the operations comprising:
receiving an application request from a user;
generating, by a machine-learned model, an initial design specification with a plurality of components for an initial structure of an application based on the application request, wherein the initial design specification comprises an intermediate representation of a design graph;
accessing a list of services available to the user;
determining, for a respective component in the plurality of components, a first service from the list of services available to the user to perform a task associated with the respective component;
configuring one or more parameters of the first service based on the application request;
producing a final design specification in which specific services have been selected and configured for each component in the initial design specification; and
converting the final design specification to a destination format.

20. One or more non-transitory computer-readable media that collectively store instructions that, when executed by one or more computing devices, cause the one or more computing devices to perform operations, the operations comprising:
receiving an application request from a user;
generating, by a machine-learned model, an initial design specification with a plurality of components for an initial structure of an application based on the application request, wherein the initial design specification comprises an intermediate representation of a design graph;
accessing a list of services available to the user;
determining, for a respective component in the plurality of components, a first service from the list of services available to the user to perform a task associated with the respective component;
configuring one or more parameters of the first service based on the application request;
producing a final design specification in which specific services have been selected and configured for each component in the initial design specification; and
converting the final design specification to a destination format.
